(19) United States
(12) Patent Application Publication
(10) Pub. No.: US 2025/0249429 A1
(43) Pub. Date: Aug. 7, 2025

(54) VOLATILE ORGANIC COMPOUND (VOC) ADSORBENT AND METHOD OF MANUFACTURING THE SAME

(71) Applicant: SAMSUNG ELECTRONICS CO., LTD., Suwon-si (KR)

(72) Inventors: Daeok KIM, Suwon-si (KR); Dongyeun KOH, Daejeon-si (KR); Woosung CHOI, Suwon-si (KR); Hansol KIM, Suwon-si (KR); Hyeonji PARK, Suwon-si (KR); Kyunam KIM, Daejeon-si (KR); Youngeun HWANG, Daejeon-si (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/020,714

(22) Filed: Jan. 14, 2025

(30) Foreign Application Priority Data
Feb. 5, 2024 (KR) 10-2024-0017540
Apr. 9, 2024 (KR) 10-2024-0048081

(51) Int. Cl. B01J 20/26; B01D 53/02; B01J 20/28; B01J 20/32

(52) U.S. Cl. CPC B01J 20/26; B01D 53/02; B01J 20/28016; B01J 20/2808; B01J 20/28083; B01J 20/3204; B01J 20/3268; B01J 20/3293; B01D 2253/202; B01D 2257/708; B01D 2258/0216

(57) ABSTRACT

A volatile organic compound adsorbent includes a honeycomb-shaped glass fiber support and a microporous polymer covering a surface of the glass fiber support. A method of manufacturing a volatile organic compound adsorbent including a polymer-glass fiber composite includes: degassing a honeycomb-shaped glass fiber support; preparing a mixed solution of a microporous polymer and a solvent; preparing a polymer-glass fiber composite in which the microporous polymer is applied onto a surface of the glass fiber support by applying the mixed solution onto the surface of the glass fiber support; and drying the polymer-glass fiber composite.

### CROSS-REFERENCE TO RELATED APPLICATIONS

This application is based on and claims priority to Korean Patent Application No. 10-2024-0017540, filed on Feb. 5, 2024, and Korean Patent Application No. 10-2024-0048081, filed on Apr. 9, 2024, in the Korean Intellectual Property Office, the disclosures of which are incorporated by reference herein in their entirety.

### BACKGROUND

The present disclosure relates to a volatile organic compound adsorbent and a method of manufacturing the same. More particularly, the present disclosure relates to a volatile organic compound adsorbent containing a microporous polymer, and to a method of manufacturing the same.

Methods (combustion, catalytic combustion, adsorption, membrane separation, condensation, etc.) are used as treatment technology for mixed substances containing organic pollutants such as volatile organic compounds (VOCs). Among these, adsorption technology is widely used since various types of organic pollutants can be collected at once, and the collected organic pollutants can be recovered at high concentrations. Meanwhile, there is a limitation in that there is deterioration in adsorption performance of the adsorbent due to structural instability of the adsorbent used in adsorption technology under acidic conditions. Therefore, a volatile organic compound adsorbent capable of maintaining structural stability even under acidic conditions is required.

### SUMMARY

The present disclosure provides an adsorbent which maintains structural stability even under acidic conditions and has improved adsorption performance of a volatile organic compound, and a method of manufacturing the same.

According to an aspect of the present disclosure, there is provided a volatile organic compound adsorbent including a honeycomb-shaped glass fiber support and a microporous polymer covering a surface of the glass fiber support.

According to an aspect of the present disclosure, there is provided a method of manufacturing a volatile organic compound adsorbent composed of a polymer-glass fiber composite, the method including: degassing a honeycomb-shaped glass fiber support; preparing a mixed solution of a microporous polymer and a solvent; preparing a polymer-glass fiber composite coated with the microporous polymer on a surface of the glass fiber support by applying the mixed solution to the surface of the glass fiber support; and drying the polymer-glass fiber composite.

According to an aspect of the present disclosure, there is provided a volatile organic compound adsorbent including a polymer-glass fiber composite which includes a honeycomb-shaped glass fiber support and a microporous polymer covering the surface of the glass fiber support, wherein the mass ratio of the glass fiber support and the microporous polymer is about 1:0.002 to about 1:0.3, and the microporous polymer includes PIM-1, PIM-7, PIM-SBF-1, PIM-SBF-2, PIM-SBF-3, PIM-SBF-4, PIM-SBF-5, PIM-EA-TB, PIM-PI-EA, PIM-Trip-TB, TPIM-1, PIM-MP-TB, PIM-EA-TB, PIM-Trip-TB, amidoxime-functionalized PIM-1 (PIM-1-AO), tetrazole-substituted PIMs (PIM-TZ), PIM-TMN-Trip, PIMBtrip, KAUST-PI-1, CF3-ROMP, or a combination thereof.

### BRIEF DESCRIPTION OF DRAWINGS

Embodiments of the present disclosure will be more clearly understood from the following detailed description taken in conjunction with the accompanying drawings in which:

FIG. 1 is a schematic diagram of a semiconductor manufacturing system including a volatile organic compound adsorbent, according to embodiments of the present disclosure;

FIG. 2 is a perspective view of a volatile organic compound adsorbent according to embodiments of the present disclosure;

FIG. 3 is a flowchart for describing a method of manufacturing a volatile organic compound adsorbent, according to embodiments of the present disclosure;

FIG. 4 is a graph showing thermogravimetric analysis results for adsorbents respectively composed of glass fibers, PIM-1, and a composite of glass fiber and PIM-1;

FIG. 5A is a graph showing a breakthrough curve for IPA on an adsorbent composed of a composite of glass fibers and PIM-1, and FIG. 5B is a graph showing a breakthrough curve for IPA on an adsorbent composed of glass fibers;

FIG. 6A is a table showing each Brunauer-Emmett-Teller (BET) surface area of a composite of glass fibers and PIM-1, a composite of HCl-treated glass fibers and PIM-1, and a composite of HF-treated glass fibers and PIM-1, FIG. 6B is a graph showing each argon adsorption amount of the composite glass fibers and PIM-1, the composite of HCl-treated glass fibers and PIM-1, and the composite of HF-treated glass fibers and PIM-1, and FIG. 6C is a graph showing each pore size distribution of the composite glass fibers and PIM-1, the composite of HCl-treated glass fibers and PIM-1, and the composite of HF-treated glass fibers and PIM-1; and

FIG. 7 is a graph showing results of X-ray diffraction (XRD) analysis on each of NaY and HCl-treated NaY.

### DETAILED DESCRIPTION

Hereinafter, embodiments of the present disclosure are described in detail with reference to the accompanying drawings. The same reference numerals are given to the same elements in the drawings, and repeated descriptions thereof are omitted.

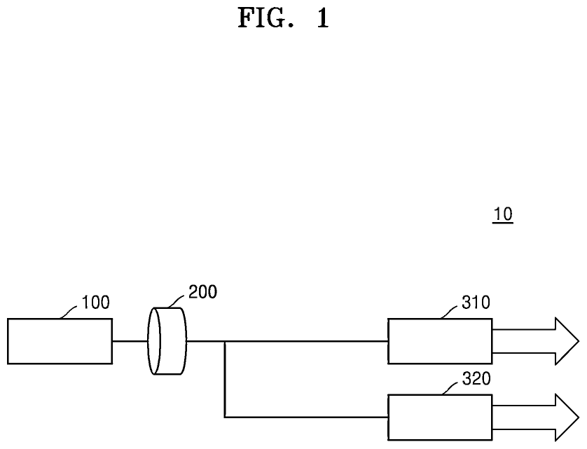

FIG. 1 is a schematic diagram of a semiconductor manufacturing system 10 including a volatile organic compound adsorbent 200, according to embodiments of the present disclosure.

Referring to FIG. 1, the semiconductor manufacturing system 10 may include semiconductor manufacturing equipment 100, the volatile organic compound adsorbent 200, a first scrubber 310, and a second scrubber 320.

The semiconductor manufacturing equipment 100 may be equipment in which a process for manufacturing a semiconductor is performed. For example, the semiconductor manufacturing equipment 100 may be equipment where processes for manufacturing a semiconductor such as a deposition process, a planarization process, and a cleaning process are performed.

The volatile organic compound adsorbent 200 may be configured to adsorb a volatile organic compound contained in exhaust gases emitted from the semiconductor manufacturing equipment 100 after the semiconductor manufacturing processes that are performed in the semiconductor manufacturing equipment 100. For example, the volatile organic compound adsorbent 200 may be isopropyl alcohol (IPA) contained in the exhaust gases.

The first scrubber 310 and the second scrubber 320 may each be configured to additionally treat the exhausted gases adsorbed by the volatile organic compound adsorbent 200. For example, the first scrubber 310 may remove acidic substances contained in the exhausted gases adsorbed by the volatile organic compound adsorbent 200, and the second scrubber 320 may remove organic substances contained in the exhausted gases adsorbed by the volatile organic compound adsorbent 200. The first scrubber 310 and the second scrubber 320 may be each a wet scrubber.

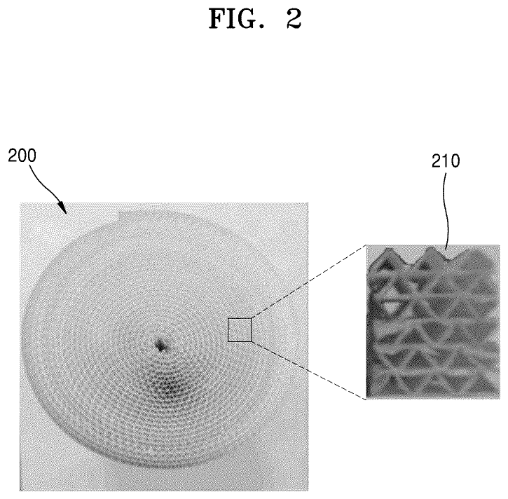

Hereinafter, the volatile organic compound adsorbent 200 will be described in more detail with reference to FIG. 2.

FIG. 2 is a perspective view of the volatile organic compound adsorbent 200 according to embodiments of the present disclosure.

Referring to FIG. 2, the volatile organic compound adsorbent 200 may have a circular disc shape. However, the technical scope of the present disclosure is not limited thereto, and the volatile organic compound adsorbent 200 may have various shapes such as a cylindrical shape. The volatile organic compound adsorbent 200 may be composed of a polymer-glass fiber composite 210.

The polymer-glass fiber composite 210 may include a glass fiber support and a microporous polymer applied on a surface of the glass fiber support. In embodiments, the glass fiber support may have a honeycomb shape. In embodiments, the microporous polymer may have any one form selected from fibers, hollow fibers, a pellet, a honeycomb monolith, and a foam. In embodiments, the microporous polymer may be composed of PIM-1, PIM-7, PIM-SBF-1, PIM-SBF-2, PIM-SBF-3, PIM-SBF-4, PIM-SBF-5, PIM-EA-TB, PIM-PI-EA, PIM-Trip-TB, TPIM-1, PIM-MP-TB, PIM-EA-TB, PIM-Trip-TB, amidoxime-functionalized PIM-1 (PIM-1-AO), tetrazole-substituted PIMs (PIM-TZ), PIM-TMN-Trip, PIMBtrip, KAUST-PI-1, CF3-ROMP, or a combination thereof.

In embodiments, the microporous polymer may have a porosity of about 20% to about 70%. In embodiments, a pore of the microporous polymer may have a diameter in a range of about 0.1 nm to about 10 nm. For purposes of this specification, the term “about” means±5%.

In embodiments, a mass ratio of the glass fiber support to the microporous polymer may be about 1:0.002 to about 1:0.3. For example, the mass ratio of the glass fiber support to the microporous polymer may be about 1:0.004, about 1:0.031, about 1:about 0.052, or about 1:0.095.

In the case of a hydrophobic zeolite-based adsorbent such as NaY, which is generally used for adsorbing a volatile organic compound, a structure thereof becomes unstable under acidic conditions and the microporous structure of the hydrophobic zeolite-based adsorbent collapses, thereby causing deterioration of the adsorption performance of the hydrophobic zeolite-based adsorbent. In addition, when a volatile organic compound was adsorbed using equipment such as a wet scrubber instead of the adsorbent, there was an environmental limitation of generating a huge amount of wastewater.

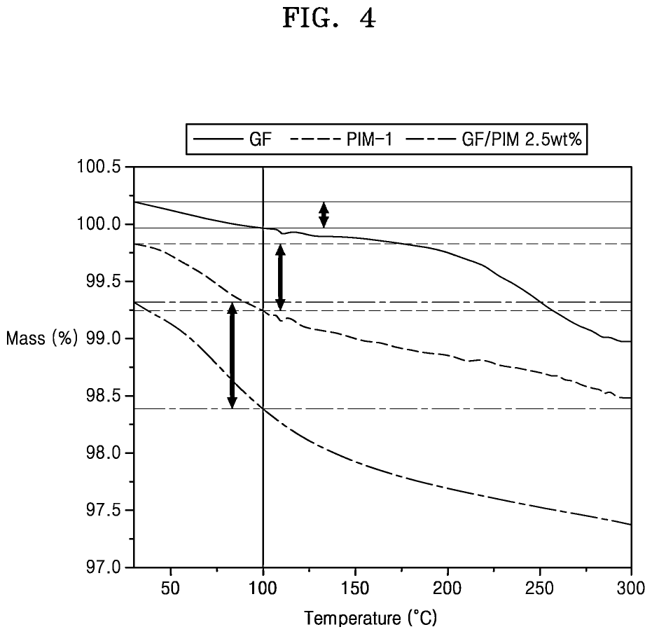

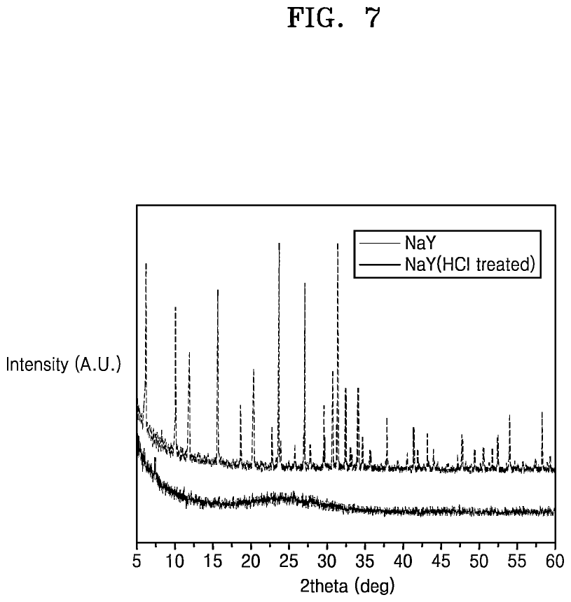

Meanwhile, the volatile organic compound adsorbent 200 according to embodiments of the present disclosure is composed of a polymer-glass fiber composite including a glass fiber support and a microporous polymer, and thus, as described later with reference to FIG. 4 and FIG. 7, has excellent structural stability even under acidic conditions. Therefore, the volatile organic compound adsorbent 200 may exhibit excellent adsorption performance even under acidic conditions. In addition, since additional water is not used in order to adsorb the volatile organic compound, costs for wastewater treatment may be reduced.

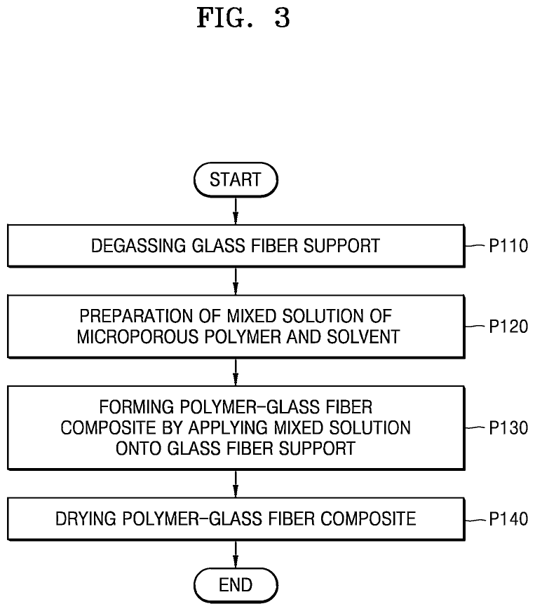

FIG. 3 is a flow chart for explaining a method of manufacturing a volatile organic compound adsorbent according to embodiments of the present disclosure.

Referring to FIG. 3, first, the provided glass fiber support may be degassed (P110). In embodiments, the glass fiber support may have a honeycomb shape. In embodiments, the glass fiber support may be degassed using a vacuum oven. In embodiments, the glass fiber support may be degassed by drying at a temperature of about 80° C. to about 120° C. for about 8 hours to about 12 hours. For example, the glass fiber support may be degassed by being dried at a temperature of about 100° C. for about 10 hours.

Then, a mixed solution of the microporous polymer and a solvent may be prepared (P120). In embodiments, the microporous polymer may have any one form selected from fibers, hollow fibers, a pellet, a honeycomb monolith, and a foam. In embodiments, the microporous polymer may be composed of PIM-1, PIM-7, PIM-SBF-1, PIM-SBF-2, PIM-SBF-3, PIM-SBF-4, PIM-SBF-5, PIM-EA-TB, PIM-PI-EA, PIM-Trip-TB, TPIM-1, PIM-MP-TB, PIM-EA-TB, PIM-Trip-TB, amidoxime-functionalized PIM-1 (PIM-1-AO), tetrazole-substituted PIMs (PIM-TZ), PIM-TMN-Trip, PIMBtrip, KAUST-PI-1, CF3-ROMP, or a combination thereof. For example, the microporous polymer may be composed of PIM-1. In embodiments, the solvent may include methyl chloride, carbon tetrachloride, tetrahydrofuran, or a combination thereof. In embodiments, a mass ratio of the microporous polymer and the solvent may be about 1:99 to about 10:90. In embodiments, a mass ratio of the microporous polymer and the solvent may be about 2.5:97.5, about 5:about 95, about 7.5:about 92.5, or about 10:about 90.

Then, the degassed glass fiber support is provided, and the mixed solution prepared during the P120 process step may be applied onto the glass fiber support to form a polymer-glass fiber composite (P130). The polymer-glass fiber composite may have a structure in which the microporous polymer is applied onto the surface of the glass fiber support having a honeycomb structure. In embodiments, the glass fiber support and the microporous polymer contained in the polymer-glass fiber composite may have a mass ratio of about 1:0.002 to about 1:0.3. For example, the glass fiber support and the microporous polymer contained in the polymer-glass fiber composite may have a mass ratio of about 1:0.004. The polymer-glass fiber composite may be formed by using, for example, one method selected from spray-coating, deep coating, and spin-coating. For example, the polymer-glass fiber composite may be formed by deep coating. For example, the deep coating may be performed by immersing the degassed glass fiber support in the mixed solution. The deep coating may be carried out, for example, for about 1 second to about 300 seconds. The deep coating may be carried out, for example, while moving the glass fiber support at a speed of about 0.1 cm/min to about 30 cm/min. For example, the deep coating may be carried out in a state where the glass fiber support is immersed in the mixed solution while moving the glass fiber support for about 1 minute at a speed of about 10 cm/min. In other embodiments, the deep coating may be performed by recovering the degassed glass fiber support immediately after immersion in the mixed solution.

Subsequently, the polymer-glass fiber composite formed through the P130 process step may be dried (P140). In embodiments, the P140 process step may include a process of drying the formed polymer-glass fiber composite in air and an additional drying process of drying the air-dried polymer-glass fiber composite in a vacuum oven. For example, the polymer-glass fiber composite may be dried in air for about 24 hours and then dried in a vacuum oven at a temperature of about 70° C. for about 12 hours. By performing the P140 process step, moisture contained in the polymer-glass fiber composite may be removed.

FIG. 4 is a graph showing the results of thermogravimetric analysis of adsorbents composed of each of glass fiber, PIM-1, and a composite of glass fiber and PIM-1, respectively. In FIG. 4, the glass fibers may correspond to the degassed glass fiber support described with reference to FIG. 3, PIM-1 may correspond to the microporous polymer described with reference to FIG. 3, and the composite of the glass fibers and PIM-1 may correspond to the polymer-glass fiber composite formed through the process steps described with reference to FIG. 3. In FIG. 4, the X-axis means temperature, and the Y-axis means mass. A mass ratio of the glass fibers and PIM-1 in the composite may be about 1:0.004.

Referring to FIG. 4, it can be seen that when heated from about 30° C. to about 300° C., the mass of the glass fibers was reduced by about 2.5%, and the mass of the composite of the glass fibers and PIM-1 was reduced by about 1.5%. That is, the results in FIG. 4 confirm that the composite of the glass fibers and PIM-1 has improved thermal stability compared to the glass fibers.

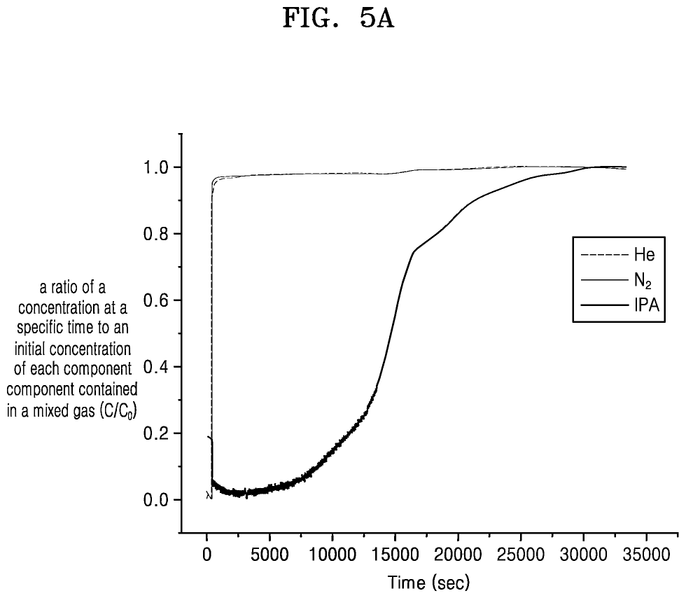

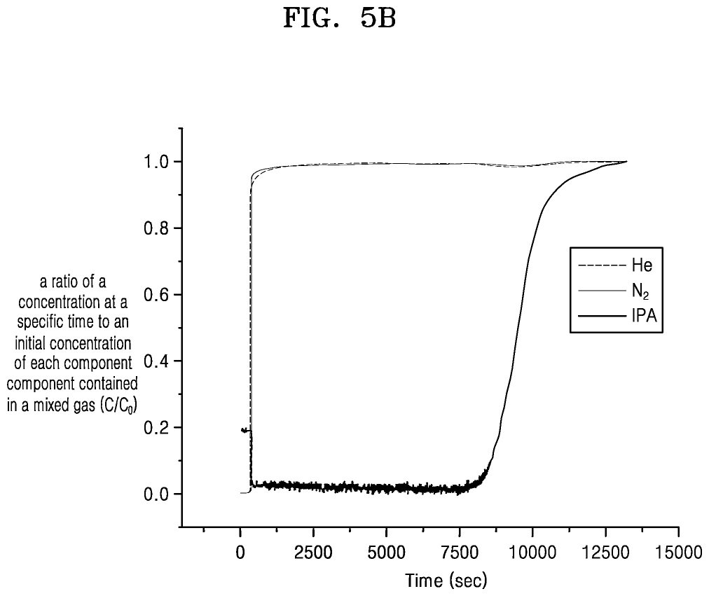

FIG. 5A is a graph showing a breakthrough curve for IPA on an adsorbent composed of the composite of glass fibers and PIM-1, and FIG. 5B is a graph showing a breakthrough curve for IPA on an adsorbent composed of the glass fibers. In FIG. 5A, the composite of the glass fibers and PIM-1 may correspond to the polymer-glass fiber composite formed through the process steps described with reference to FIG. 3, and in FIG. 5B, the glass fibers may correspond to the degassed glass fiber support described with reference to FIG. 3. In FIG. 5A and FIG. 5B, the X-axis means execution time of adsorption, and the Y-axis means a ratio of a concentration at a specific time to an initial concentration of each component contained in a mixed gas. The mass ratio of the glass fibers and PIM-1 in the composite of FIG. 5A may be about 1:0.095, and the mass of the glass fibers in FIG. 5A may be about 3.515 g. The mass of the glass fibers in FIG. 5B may be about 2.530 g.

In each of FIG. 5A and FIG. 5B, the breakthrough curve for IPA was obtained by performing adsorption using a fixed-bed continuous flow reactor. The adsorption was performed using a mixed gas with a composition of IPA 500 ppm, He 500 ppm and a balance of N₂, under conditions of 1 bar, 25° C., and 0% of relative humidity. Before the adsorption, the composite of the glass fibers and PIM-1 was dried for at least 6 hours at 100° C. and in vacuum for the degassing of the composite of the glass fibers and PIM-1, the dried composite of the glass fibers and PIM-1 was mounted in a breakthrough equipment, and then was subjected to a pre-treatment process, in which Ar gas was flowed at a flow rate of 400 sccm for 30 minutes under conditions of 1 bar and 25° C. Then, the adsorption was performed on the composite of the glass fibers and PIM-1, on which the pre-treatment process was performed under the above-described conditions while flowing the mixed gas of the above composition into the reactor at a flow rate of 400 sccm.

Referring to FIG. 5A, it can be seen that the composite of the glass fibers and PIM-1 adsorbed about 3.338 mol of IPA while performing adsorption. In FIG. 5A, it can be confirmed that since the glass fibers having the mass of about 3.515 g were used in adsorption, an adsorption amount per gram of the composite of the glass fibers and PIM-1 was about 0.950 mmol/g.

Meanwhile, referring to FIG. 5B, it can be seen that the glass fibers adsorbed about 2.098 mol of IPA while performing adsorption. In FIG. 5B, it can be confirmed that since the glass fibers having a mass of about 2.530 g were used in adsorption, an adsorption amount per gram of the glass fibers was about 0.829 mmol/g.

That is, referring to FIG. 5A and FIG. 5B, it can be confirmed that adsorption performance of IPA on the composite of the glass fibers and PIM-1 may be improved compared to adsorption performance of IPA on the glass fibers.

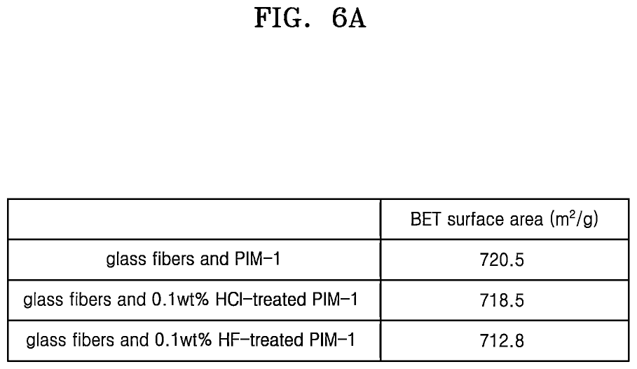

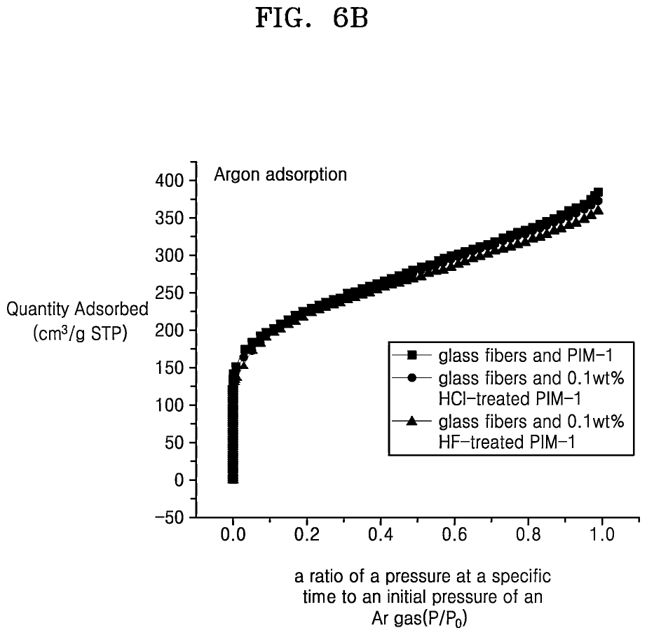

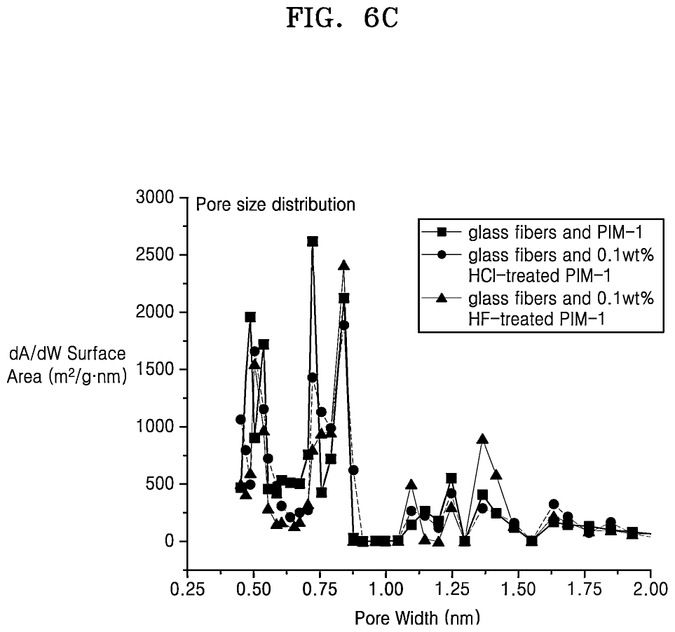

FIG. 6A is a table showing the BET surface area of each of the composite of the glass fibers and PIM-1, a composite of HCl-treated glass fibers and PIM-1, and a composite of HF-treated glass fibers and PIM-1, FIG. 6B is a graph showing the argon adsorption amount of each of the composite of the glass fibers and PIM-1, the composite of HCl-treated glass fibers and PIM-1, and the composite of HF-treated glass fibers and PIM-1, and FIG. 6C is a graph showing the degree of pore size distribution of each of the composite of the glass fibers and PIM-1, the composite of HCl-treated glass fibers and PIM-1, and the composite of HF-treated glass fibers and PIM-1. In FIG. 6B, the X-axis means a ratio of a pressure at a specific time to an initial pressure of an Ar gas, and the Y-axis means an adsorption amount. In FIG. 6C, the X-axis means a diameter of a micropore of the microporous polymer, and the Y-axis means a surface area of the micropore of the microporous polymer. In FIG. 6A, FIG. 6B, and FIG. 6C, the glass fibers and PIM-1 in the composite may have a mass ratio of about 1:0.095.

In FIG. 6A, FIG. 6B, and FIG. 6C, three composites of glass fibers and PIM-1 corresponding to the polymer-glass fiber composite formed through the process steps with reference to FIG. 3 were prepared. Subsequently, one composite of the glass fibers and PIM-1 was immersed in an HF aqueous solution of 0.1 wt %, and another composite of the glass fibers and the PIM-1 was immersed in an HCl aqueous solution of 0.1 wt %, each for about 24 hours. Subsequently, the immersed composite of the glass fibers and PIM-1 in the HF aqueous solution and the immersed composite of the glass fibers and PIM-1 in the HCl aqueous solution were recovered, and each was soaked in distilled water. Then, the composite of the glass fibers and PIM-1 soaked in the distilled water was sufficiently dried at room temperature. Subsequently, each of the composite of the glass fibers and PIM-1, the composite of the glass fibers and PIM-1 treated with HCl, and the composite of the glass fibers and PIM-1 treated with HF was dried in a vacuum oven for about 12 hours, and then a BET surface area, an adsorption amount of Ar gas, and a pore size distribution of each of the composite of the glass fibers and PIM-1, the composite of the glass fibers and PIM-1 treated with HCl, and the composite of the glass fibers and PIM-1 treated with HF was measured while Ar gas was adsorbed under conditions of 1 bar and 25° C.

Referring to FIG. 6A, it can be confirmed that the composite of the glass fibers and PIM-1 without any treatment, the composite of the glass fibers and PIM-1 treated with HCl, and the composite of the glass fibers and PIM-1 treated with HF have the BET surface areas of 720.5 m²/g, 718.5 m²/g, and 712.8 m²/g, respectively, and each composite corresponds to the polymer-glass fiber composite formed through the process steps described with reference to FIG. 3.

That is, referring to FIG. 6A, it can be confirmed that the composite of the glass fibers and PIM-1 without any treatment, the composite of the glass fibers and PIM-1 treated with HCl, and the composite of the glass fibers and PIM-1 treated with HF have similar BET surface areas.

Referring to FIG. 6B, it can be confirmed that the composite of the glass fibers and PIM-1 without any treatment, the composite of the glass fibers and PIM-1 treated with HCl, and the composite of the glass fibers and PIM-1 treated with HF have similar Ar adsorption amounts, and each composite corresponds to the polymer-glass fiber composite formed through the process steps described with reference to FIG. 3.

Referring to FIG. 6C, it can be confirmed that the composite of the glass fibers and PIM-1 without any treatment, the composite of the glass fibers and PIM-1 treated with HCl, and the composite of the glass fibers and PIM-1 treated with HF have similar pore size distributions, and each composite corresponds to the polymer-glass fiber composite formed through the process steps described with reference to FIG. 3.

That is, referring to FIG. 6A, FIG. 6B, and FIG. 6C, it can be seen that the composite of the glass fibers and PIM-1 without any treatment and the composite of the glass fibers and PIM-1 treated with HF or HCl have similar BET surface areas, similar argon adsorption amounts, and similar pore size distributions. That is, it can be confirmed that the composite of the glass fibers and PIM-1 corresponding to the polymer-glass fiber composite formed through the process steps described with reference to FIG. 3 has structural stability even under an acidic condition.

In addition, for evaluating the structural stability of the composite of the glass fibers and PIM-1 and the structural stability of the glass fibers, even under an acidic condition, the glass fibers of 0.343 g and the composite of the glass fibers and PIM-1 of 0.343 g were immersed in 10 wt % of HF aqueous solution for about 10 hours, and then the residual mass thereof was measured. As a result of the mass measurement, the glass fibers of 0.343 g were completely dissolved, but the residual presence of the composite of the glass fibers and PIM-1 of 0.343 g was confirmed while maintaining the honeycomb shape.

Meanwhile, for evaluating the structural stability of NaY, which is generally used for IPA adsorption, under the acidic conditions, 0.124 g of NaY and 0.152 g of NaY were immersed in a 0.1 wt % HF aqueous solution of 100 mL and a 0.1 wt % HCl aqueous solution of 100 mL, respectively, for 24 hours, the immersed NaY was soaked in distilled water, then the NaY soaked in the distilled water was sufficiently dried at room temperature, and then the mass was measured. As a result of the mass measurement, HF-treated NaY of 0.124 g was completely dissolved, and in a case of HCl-treated NaY of 0.152 g, only NaY of 0.095 g remained. Hereinafter, X-ray diffraction (XRD) analysis on NaY remaining after HCl treatment will be described.

FIG. 7 is a graph showing results of X-ray diffraction (XRD) analysis on each of NaY and HCl-treated NaY.

Referring to FIG. 7, it can be confirmed that XRD patterns of untreated NaY and NaY remaining after HCl treatment are different from each other. That is, referring to FIG. 7, it can be confirmed that the remained NaY after HCl treatment has damaged crystallinity, and thus no significant peak is observed in the XRD pattern.

Referring to the processes for evaluating the structural stability of the above-described NaY and FIG. 7, it can be confirmed that NaY generally used for IPA adsorption has deteriorated structural stability under the acidic conditions.

That is, referring to FIG. 6A, FIG. 6B, FIG. 6C, and FIG. 7, it can be confirmed that the polymer-glass fiber composite according to embodiments of the present disclosure has improved structural stability even under acidic conditions compared to the hydrophobic zeolite generally used for IPA adsorption.

As above, embodiments have been disclosed in the drawings and specification. Although embodiments have been described in this specification using specific terminology, this is only used for the purpose of explaining the technical idea of the present disclosure and is not used to limit the meaning or scope of the present disclosure described in the claims. Therefore, it will be understood by those skilled in the art that various modifications and other equivalent embodiments can be made from the embodiments. Hence, the real protective scope of the present disclosure should be determined by the appended claims.

While the present disclosure has been particularly shown and described with reference to embodiments thereof, it will be understood that various changes in form and details may be made therein without departing from the spirit and scope of the following claims.

What is claimed is:

1. A volatile organic compound adsorbent comprising:
a honeycomb-shaped glass fiber support, and
a microporous polymer covering a surface of the glass fiber support.

2. The volatile organic compound adsorbent of claim 1,
wherein a mass ratio of the glass fiber support and the microporous polymer is about 1:0.002 to about 1:about 0.3.

3. The volatile organic compound adsorbent of claim 1,
wherein the microporous polymer comprises PIM-1, PIM-7, PIM-SBF-1, PIM-SBF-2, PIM-SBF-3, PIM-SBF-4, PIM-SBF-5, PIM-EA-TB, PIM-PI-EA, PIM-Trip-TB, TPIM-1, PIM-MP-TB, PIM-EA-TB, PIM-Trip-TB, amidoxime-functionalized PIM-1 (PIM-1-AO), tetrazole-substituted PIMs (PIM-TZ), PIM-TMN-Trip, PIMBtrip, KAUST-PI-1, CF3-ROMP, or a combination thereof.

4. The volatile organic compound adsorbent of claim 1,
wherein the microporous polymer has any one form selected from fibers, hollow fibers, a pellet, a honeycomb monolith, and foam.

5. The volatile organic compound adsorbent of claim 1,
wherein the microporous polymer has a porosity of about 20% to about 70%.

6. The volatile organic compound adsorbent of claim 1,
wherein a pore of the microporous polymer has a diameter in a range of about 0.1 nm to about 10 nm.

7. The volatile organic compound adsorbent of claim 1,
wherein the volatile organic compound adsorbent has a circular disc shape.

8. A method of manufacturing a volatile organic compound adsorbent comprising a polymer-glass fiber composite, the method comprising:
degassing a honeycomb-shaped glass fiber support;
preparing a mixed solution of a microporous polymer and a solvent;
preparing a polymer-glass fiber composite in which the microporous polymer is applied onto a surface of the glass fiber support by applying the mixed solution onto the surface of the glass fiber support; and
drying the polymer-glass fiber composite.

9. The method of claim 8,
wherein a mass ratio of the microporous polymer to the solvent included in the mixed solution is about 2.5:97.5 to about 10:90.

10. The method of claim 8,
wherein a mass ratio of the glass fiber support to the microporous polymer is about 1:0.002 to about 1:about 0.3.

11. The method of claim 8,
wherein the microporous polymer has a porosity of about 20% to about 70% and a pore diameter in a range of about 0.1 nm to about 10 nm.

12. The method of claim 8,
wherein the applying of the mixed solution onto the surface of the glass fiber support is performed using a deep coating method.

13. The method of claim 12,
wherein the deep coating method is performed in a state in which the glass fiber support is immersed in the mixed solution for a time selected from within a range of about 1 second to about 300 seconds while moving the glass fiber support at a speed selected from within a range of about 0.1 cm/min to about 30 cm/min.

14. The method of claim 8,
wherein the microporous polymer comprises PIM-1, PIM-7, PIM-SBF-1, PIM-SBF-2, PIM-SBF-3, PIM-SBF-4, PIM-SBF-5, PIM-EA-TB, PIM-PI-EA, PIM-Trip-TB, TPIM-1, PIM-MP-TB, PIM-EA-TB, PIM-Trip-TB, amidoxime-functionalized PIM-1 (PIM-1-AO), tetrazole-substituted PIMs (PIM-TZ), PIM-TMN-Trip, PIMBtrip, KAUST-PI-1, CF3-ROMP, or a combination thereof.

15. The method of claim 8,
wherein the microporous polymer has any one form selected from fibers, hollow fibers, a pellet, a honeycomb monolith, and foam.

16. The method of claim 8,
wherein, in the drying of the polymer-glass fiber composite, the polymer-glass composite is dried in air, and then the air-dried polymer-glass fiber composite is dried in a vacuum oven.

17. A volatile organic compound adsorbent comprising a polymer-glass fiber composite comprising:
a honeycomb-shaped glass fiber support, and
a microporous polymer covering a surface of the glass fiber support, wherein the microporous polymer has a mass ratio of the glass fiber support to the microporous polymer of about 1:0.002 to about 1:0.3,
wherein the microporous polymer comprises PIM-1, PIM-7, PIM-SBF-1, PIM-SBF-2, PIM-SBF-3, PIM-SBF-4, PIM-SBF-5, PIM-EA-TB, PIM-PI-EA, PIM-Trip-TB, TPIM-1, PIM-MP-TB, PIM-EA-TB, PIM-Trip-TB, amidoxime-functionalized PIM-1 (PIM-1-AO), tetrazole-substituted PIMs (PIM-TZ), PIM-TMN-Trip, PIMBtrip, KAUST-PI-1, CF3-ROMP, or a combination thereof.

18. The volatile organic compound adsorbent of claim 17,
wherein the microporous polymer has any one form selected from fibers, hollow fibers, a pellet, a honeycomb monolith, and foam.

19. The volatile organic compound adsorbent of claim 17,
wherein the microporous polymer has a porosity of about 20% to about 70% and a pore diameter in a range of about 0.1 nm to about 10 nm.

20. The volatile organic compound adsorbent of claim 17,
wherein the volatile organic compound adsorbent has a circular disc shape.
